(19) United States
(12) Patent Application Publication
(10) Pub. No.: US 2015/0287245 A1
(43) Pub. Date: Oct. 8, 2015

(54) TESTING APPARATUS FOR VISUAL SYSTEMS

(71) Applicant: AIRBUS DEFENCE AND SPACE GMBH, Ottobrunn (DE)

(72) Inventors: Emanuel ERMANN, Oberstimm (DE); Daniel WERNER, Petershausen (DE); Oliver KREBS, Weichering (DE); Marco SCHAD, Steinkirchen (DE); Ralf CASPARI, Koesching (DE)

(73) Assignee: AIRBUS DEFENCE AND SPACE GMBH, Ottobrunn (DE)

(21) Appl. No.: 14/678,203

(22) Filed: Apr. 3, 2015

(30) Foreign Application Priority Data
Apr. 5, 2014 (DE) 102014005030.0

(51) Int. Cl. G06T 19/00; G06T 7/00; G02B 27/01

(52) U.S. Cl. CPC G06T 19/006; G02B 27/0149; G06T 7/004; G02B 2027/0163

(57) ABSTRACT

Testing apparatus and method for testing visual systems, e.g., augmented visual systems, having a viewing unit. The testing apparatus includes a moveable holding device, which is structured to hold the viewing unit and to move the viewing unit with a rotational degree of freedom; a position detection unit structured to detect a position and an alignment of the viewing unit; and a test-conducting unit coupled to receive a detected position and an alignment of the viewing unit from the position detection unit. The test-conducting unit is configured to determine a field of view as a function of the detected position and alignment of the viewing unit, to read-in an actual field of view displayed by the viewing unit and to compare the determined field of view with the read-in actual field of view.

### CROSS-REFERENCE TO RELATED APPLICATIONS

The present application claims priority under 35 U.S.C. §119 of German Patent Application No. DE 10 2014 005 030.0, filed Apr. 5, 2014, the disclosure of which is expressly incorporated by reference herein in its entirety.

### BACKGROUND OF THE EMBODIMENTS

1. Field of the Invention

Embodiments of the present invention relate to a testing apparatus for visual systems, in particular, for visual systems with augmented fields of view, and to a method of using such a testing apparatus to test visual systems with augmented fields of view (also referred to as augmented visual systems).

2. Discussion of Background Information

Augmented visual systems are typically used to superimpose supplementary information onto the field of view of a human viewer, which information relates to, e.g., objects located in the field of view. For these objects, information such as, e.g., position, speed, direction of movement or other information can be displayed.

Augmented visual systems comprise a translucent unit, which can generally be referred to as a viewing unit, which is located in front of the eyes of a human viewer or user in the viewing direction, so that the viewer views the field of vision presented to him through the translucent unit. If any objects are located in the field of vision of the viewer, the above-referenced supplementary information can be shown for these objects on the translucent unit as on a display or a projection surface. A viewing unit can also be designed to project or map information onto the retina of a user or viewer.

Such visual systems can be embodied such that at least the viewing unit is a portable system and is coupled to a control unit of the visual system in such a manner that an exchange of data between the viewing unit and the control unit of the visual system can occur, in order to enable the display of information supplied by the control unit on the viewing unit.

The control unit is designed to detect the spatial alignment of the viewing unit and to supply the information corresponding to this alignment to the viewing unit. In other words: If a viewer has positioned the viewing unit in front of his eyes and coupled it to his head, and if the viewer turns or tilts his head, the relative position of the objects located in the field of view of the viewer changes in relation to the viewing unit. Thus, it can occur that new objects can be seen through the viewing unit and/or that the objects already located in the field of view are seen in a different position by the eyes of the viewer through the viewing unit. As a result, the contents of the information augmenting the field of view change, as does the position of the information. For example, it may be desired that the information displayed for an object be positioned next to an object and follow the movements of the object on the viewing unit.

For this purpose, the control unit receives position information that relates to the viewing unit, i.e., the viewing direction in relation to three axes in space and the aperture angle of the viewing unit, which angle defines the field of view.

Such augmented visual systems can, e.g., be a piece of headgear for the head of a viewer, in particular in the form of a helmet, the visor of which is designed as a viewing unit. An augmented visual system can also be a piece of headgear in the form of eyeglasses.

A visual system can also be coupled to a vehicle (aircraft, ground vehicle, watercraft) and be designed in the form of a pane (windshield, rear window, side window), for example. The position of the viewer relative to this visual system can thereby also be detected, in order to determine the information that is to be displayed on the viewing unit, as well as the position of this information.

The testing of an augmented visual system can entail a high cost. The position and alignment of the viewing unit must be modified for different uses and applications, and the image displayed must be calibrated with the image expected. The displayed or expected image can generally be referred to as a displayed or expected field of view that is composed of the real objects that are located in front of the eyes of the viewer and the information displayed on the viewing unit, i.e., virtual objects or information.

### SUMMARY OF THE EMBODIMENTS

Embodiments of the invention reduce the cost for testing visual systems, in particular augmented visual systems.

According to one aspect, a testing apparatus for testing visual systems is described. The testing apparatus comprises a moveable holding device, a position detection unit and a test-conducting unit. The moveable holding device is designed to hold a viewing unit of the visual system and is designed to perform a movement of the viewing unit with a rotational degree of freedom. The position detection unit is designed to detect the position and the alignment of the viewing unit. The test-conducting unit is coupled to the position detection unit such that a detected position and alignment of the viewing unit can be transmitted to the test-conducting unit, wherein the test-conducting unit is also designed to determine a field of view as a function of the detected position and alignment of the viewing unit and wherein the test-conducting unit is furthermore designed to read in a field of view actually displayed by the viewing unit and to compare the determined field of view with the field of view read in.

The moveable holding device can, e.g., be controlled by the test-conducting unit and can thereby perform a specified series of movements or positionings of the viewing unit. In other words, the test-conducting unit can be designed to control the holding device such that the viewing unit follows specified movement patterns. Depending on these movement patterns, the field of view, i.e., the information displayed on the viewing unit and the position of this information, varies. In particular, the field of view can contain data, e.g., in the form of alphanumeric characters, which is displayed on a display unit of the viewing unit. In the case of viewing units that map or project information onto the retina of the user, the field of view can be the mapped or projected data or information.

In the context of this specification, the term “position of the viewing unit” is to be generally understood as meaning the arrangement of the viewing unit in space, which includes, e.g., the spatial position of the viewing unit as such and the intended viewing direction, i.e., a direction perpendicular to a plane of the viewing unit.

The test-conducting unit is designed to position the holding device by transmitting control information to the holding device and to thus specify a reference position of the viewing unit. The reference position of the viewing unit is subsequently transmitted to the control unit of the visual system, and the field of view based on this reference position is determined by the control unit. This determined field of vision is the reference field of vision, based on the specified reference position of the holding device and the viewing unit.

The position detection unit determines the position and the alignment of the viewing unit and transmits these to the control unit, so that the control unit transmits field of view data to the viewing unit based on the information from the position detection unit.

The test-conducting unit is designed to read in the field of view data transmitted by the control unit to the viewing unit. The field of view that is read in is the actual field of view.

Both the reference field of view and also the actual field of view can in particular be characterized in terms of the data or information that is to be displayed on the viewing unit, as well as its position on the viewing unit, so that a field-of-view calibration involves, e.g., a calibration of the data or information that is to be displayed, as well as its position.

By a calibration of the determined field of view with the field of view that is read in, the test-conducting unit can determine whether the control unit of the visual system is transmitting the correct field of view, i.e., the field of view expected depending on the position and alignment of the viewing unit.

Before a test of this type is performed, the position coordination of the holding device and the position coordinates determined by the position detection unit must be equalized. This can occur, e.g., in that the viewing unit is mechanically coupled to the holding device, in particular, coupled to the holding device in a reversible and fixed manner. In the case of a viewing unit in the form of a piece of headgear for a viewer, this coupling corresponds to the fitting of the headgear onto the head. The equalizing of the position of the holding device with the position of the viewing unit results in the reference field of view being equal to the actual field of view in this initial position.

The holding device is moveable and is designed such that its position and alignment can be specified by the test-conducting unit. The holding device can also be moved such that the movement has a rotational degree of freedom, i.e., that the holding device can perform a rotational movement about a rotation axis.

Such a rotational movement of the holding device corresponds to the change in the alignment of the viewing unit. In the context of use by a viewer, this is equivalent to the tilting or turning of the head, so that at least the viewing direction and the alignment of the viewing unit change.

The position detection unit is designed to detect the position and the alignment of the viewing unit. The position detection unit can comprise one or multiple sensors. At least one sensor can thereby be mechanically coupled to the viewing unit, i.e., designed such that it is integrated with the viewing unit, so that this at least one sensor can detect a movement or positioning of the viewing unit. Furthermore, at least one sensor can be arranged spatially separate (i.e., without a direct connection in the form of a mechanical coupling, via which a translational or rotational movement of the viewing unit is directly transmitted to the sensor) from the viewing unit and can, e.g., detect the position and the alignment of the viewing unit via optical detectors. In one embodiment, all sensors of the position detection unit can be mechanically coupled to the viewing unit. In another embodiment, all sensors of the position detection unit can be spatially separate from the viewing unit.

Thus, two functional connections are present: (a) the test-conducting unit with the holding device and (b) the position detection unit with the viewing unit. The holding device is also mechanically coupled to the viewing unit, and a movement of the holding device alters the position and alignment of the viewing unit. The connection (a) defines the determined field of view, as described above, whereas connection (b) defines the field of view displayed on the viewing unit and read in by the test-conducting unit.

The testing of the viewing unit or of the visual system thus occurs in a closed test loop (in what is referred to as closed loop testing) with four components, as referred to in the connections (a) and (b).

The testing apparatus thus enables a reproducible and accurate positioning of the viewing unit of the visual system.

A movement pattern can be tested multiple times; the test results are thus reproducible, since the holding device can repeatedly perform a movement pattern with high precision. The finding of discrepancies between the calculated field of view and the read-in field of view is simplified, as is the identification of the causes of these discrepancies.

The sequence of a test run can be determined in advance and can proceed automatically in that the test-conducting unit actuates the holding device to complete a specified movement pattern once or multiple times and to perform an continuous calibration of the determined field of view with the read-in field of view and to log the results of this calibration for subsequent evaluation.

The determination and reading in of the corresponding field of view can occur under a real-time condition, i.e., within a predetermined span of time.

The specified movement pattern can be simulated human head movements. A corresponding movement of the viewing unit and of the respective field of view displayed by the viewing unit is detected continuously and transmitted to the test-conducting unit at runtime.

The position detection unit can be designed to continuously detect the position of the viewing unit under a predetermined time condition.

According to one embodiment, the test-conducting unit is designed to be coupled to a control unit of the viewing system and to read in a field of view transmitted to the viewing unit by the control unit, so that the field of view read in by the test-conducting unit corresponds to the field of view transmitted to the viewing unit by the control unit.

This functional link corresponds to the connection (b) referenced above.

According to a further embodiment, the test-conducting unit is designed to cyclically retrieve a position of the viewing unit detected by the position detection unit.

In particular, this cyclical retrieval can occur under a predetermined time condition and thus provide the viewing unit with a continuous supply of position information.

According to a further embodiment, the test-conducting unit is designed to re-determine the determined field of view after each retrieval of the detected position and to once again read in the field of view transmitted by the control unit and to calibrate the determined field of view with the read-in field of view after each retrieval of the detected position.

According to a further embodiment, the holding device is designed to perform a movement of the viewing unit with three rotational degrees of freedom.

The viewing unit can thus be moved as if one rotation each were to occur about three independent rotation axes of the viewing unit. The holding device does not necessarily execute a rotational movement thereby; rather, it ensures that at least the viewing unit performs a rotational movement.

In particular, the holding device can be embodied such that it can perform respectively one rotational movement of the viewing unit about three rotation axes positioned perpendicularly to one another. These three rotation axes can be the three coordinate axes of a three-dimensional Cartesian coordinate system.

According to a further embodiment, the holding device is embodied as a controllable robot arm.

A good reproducibility of a movement pattern is enabled by a robot arm, since a robot arm can repeatedly perform a specified movement pattern with high precision. In particular, a long-term test or endurance test can thus be advantageously performed.

According to a further embodiment, the robot arm comprises six segments that can be actuated separately from one another and allows a positioning of the viewing unit along three translational and three rotational degrees of freedom.

A translational positioning or movement is a movement along one or multiple axes, wherein these axes can in particular be three rotation axes. In the translational movement, a free translational motion can occur in space.

According to a further embodiment, the holding device is designed to only move the viewing unit rotationally. In this embodiment, a footprint necessary for the test can be kept small, since translational movements of the holding device and the viewing unit are omitted.

According to a further embodiment, the position detection unit comprises at least one sensor from the group composed of optical sensors, accelerometers, position sensors, extensometers.

The optical sensors can determine the position and/or alignment of the viewing unit directly by detecting the viewing unit or indirectly by detecting the position of marking elements that are arranged on the viewing unit.

Accelerometers can detect a change in position in a specified direction of motion. The position detection unit can comprise multiple accelerometers, of which at least one is respectively designed to detect a movement in a specified direction of motion. With three accelerometers, the component of a movement in space can thus occur in the direction of all three axes in space.

Position sensors and extensometers can detect the absolute position of the viewing unit, such as the inclination in reference to an initial position, for example. Several of these sensors can also be provided thereby, so that each axis in space is detected by at least one sensor.

According to a further embodiment, the position detection unit comprises two optical sensors, each in the form of an image acquisition unit.

The image acquisition unit can be a camera, e.g., a high-speed camera which enables multiple image acquisitions of the viewing unit per second.

The image acquisition units are arranged at a distance from one another, so that the viewing unit is detected from two different perspectives, in order to allow a determination of the spatial position of the viewing unit.

According to another aspect, the use of a testing apparatus as described above and below to test augmented visual systems is specified.

The testing apparatus as described above and below carries out a procedure as follows: actuation of the holding device by the test-conducting unit, so that the holding device performs a movement which elicits a rotational movement on the viewing unit about at least one rotation axis; detection of a position of the viewing unit and detection of a spatial alignment of the viewing unit, each by the position detection unit; determination of a field of view based on the detected position and alignment; display of a field of view in the viewing unit and reading in of the field of view displayed in the viewing unit; calibration of the field of view that is read in with the field of view determined by the test-conducting unit.

This procedure can be carried out cyclically and is particularly suitable for long-term tests of viewing units, in particular augmented viewing units.

To test the viewing unit, the unit can be aimed at a real scenario, so that a human viewer could view the actually present scenario through the viewing unit. The objects in the actually present scenario can be provided with supplementary information. Alternatively, the viewing unit can be aimed at a virtual scenario, e.g. at a display on which a two-dimensional or three-dimensional scenario is shown, which scenario can be a static or a dynamic scenario, i.e., in which the objects do not move or move, respectively.

Embodiments of the invention are directed to a testing apparatus for testing visual systems having a viewing unit. The testing apparatus includes a moveable holding device, which is structured to hold the viewing unit and to move the viewing unit with a rotational degree of freedom; a position detection unit structured to detect a position and an alignment of the viewing unit; and a test-conducting unit coupled to receive a detected position and an alignment of the viewing unit from the position detection unit. The test-conducting unit is configured to determine a field of view as a function of the detected position and alignment of the viewing unit, to read-in an actual field of view displayed by the viewing unit and to compare the determined field of view with the read-in actual field of view.

According to embodiments, the visual systems can further have a control unit, and the test-conducting unit can be further configured to be coupleable to the control unit. The control unit can be configured to transmit a field of view to the viewing unit and the test-conducting unit, and the transmitted field of view may be read-in by the test-conducting unit as the read-in actual field of view. The test-conducting unit may be further configured to cyclically retrieve the detected position and alignment of the viewing unit from the position detection unit. Further, the test-conducting unit can be further configured to, after each retrieval of the detected position and alignment of the viewing unit, re-determine the field of view, read-in the field of view transmitted by the control unit and calibrate the re-determined field of view with the read-in field of view.

In embodiments of the invention, the holding device can be structured to move the viewing unit with three rotational degrees of freedom.

In accordance with other embodiments of the invention, the holding device may be structured as a controllable robot arm. The can include six segments that are separately controllable from one another to enable a positioning of the viewing unit along three translational and three rotational degrees of freedom.

According to still other embodiments, the position detection unit may include at least one of an optical sensor, an accelerometer, a position sensor and an extensometers.

Further, the position detection unit can include two optical sensors. Each of the optical sensors can form an image acquisition unit.

Embodiments of the invention are directed to a method of testing, with the testing apparatus described above, an augmented visual system having a viewing unit. The method includes moving the viewing unit with a rotational degree of freedom; detecting the position and alignment of the viewing unit; determining a field of view as a function of the detected position and alignment of the viewing unit; and comparing the determined field of view with an actual field of view displayed by the viewing unit.

Embodiments of the invention are directed to a method of testing an augmented visual system having a viewing unit. The method includes moving the viewing unit with a rotational degree of freedom; detecting the position and alignment of the viewing unit; determining a field of view as a function of the detected position and alignment of the viewing unit; and comparing the determined field of view with an actual field of view displayed by the viewing unit.

According to embodiments, the augmented visual systems can further have a control unit, and the method may further include receiving, as the actual field of view displayed by the viewing unit, a field of view transmitted by the control unit to the viewing unit. The method can also include cyclically retrieving the detected position and alignment of the viewing unit; and after each retrieval of the cyclically retrieved detected position and alignment of the viewing unit: re-determining the field of view; reading-in the field of view transmitted by the control unit; and calibrating the re-determined field of view with the read-in field of view.

According to embodiments, the moving of the viewing unit with a rotational degree of freedom can include moving the viewing unit with three rotational degrees of freedom.

Moreover, the viewing unit can be coupled to a controllable robot arm having six segments that are separately controllable from one another, and the moving of the viewing unit with a rotational degree of freedom may include positioning the viewing unit along three translational and three rotational degrees of freedom.

According to other embodiments of the invention, the detecting of the position and alignment of the viewing unit can include receiving signals from at least one of an optical sensor, an accelerometer, a position sensor and an extensometers.

In accordance with still other embodiments, the detecting of the position and alignment of the viewing unit can include receiving signals from at least two optical sensors.

Embodiments of the invention are directed to a testing apparatus for testing visual systems having a viewing unit and a control unit. The testing apparatus includes a holding device, which is structured to hold the viewing unit and to move the viewing unit along three rotational degree of freedom; a position detection unit comprising at least two sensors structured and arranged to cyclically detect a position and the alignment of the viewing unit; and a test-conducting unit coupled to receive the cyclically detected position and an alignment of the viewing unit from the position detection unit. For each detected position and alignment of viewing unit, the test-conducting unit is configured to determine a field of view as a function of the detected position and alignment of the viewing unit, to read-in a field of view transmitted from the control unit to be displayed by the viewing unit and to compare the determined field of view with the read-in field of view.

In accordance with still yet other embodiments of the present invention, the test conducting unit can further be configured to calibrate the read-in field of view transmitted by the control unit based upon the comparison with the determined field of view.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic illustration of a testing apparatus according to an exemplary embodiment.

FIG. 2 shows a schematic illustration of a part of a testing apparatus according to a further exemplary embodiment.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

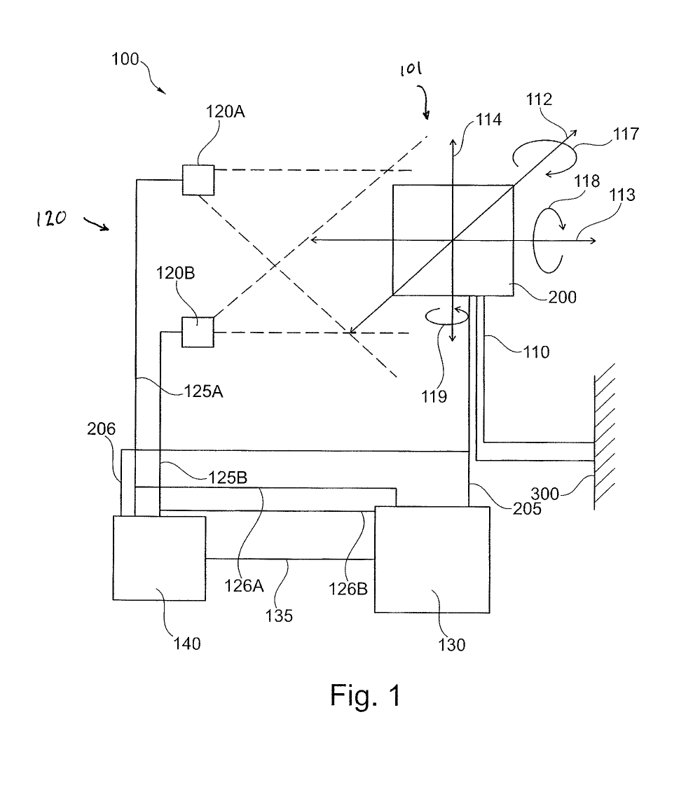

FIG. 1 shows a testing apparatus 100 having a holding device 110, a position detection unit 120 having two optical sensors 120A, 120B and a test-conducting unit 140.

Testing apparatus 100 can be coupled to test a visual system 101, e.g., an augmented visual system, that comprises a control unit 130 and a viewing unit 200.

Holding device 110 is mechanically coupled to a mounting element 300 (e.g., a wall or a frame of a housing in or to which holding device 110 and viewing unit 200 are arranged). Holding device 110 is moveable in such a manner that viewing unit 200, which is attached to holding device 110, can perform three rotational degrees of freedom movements about rotation axes 112, 113, 114, as indicated by respective rotation arrows 117, 118, 119.

The position detection unit 120 with optical sensors 120A, 120B detects a position and alignment or viewing direction of viewing unit 200 and transmits the corresponding information to test-conducting unit 140 and control unit 130 via lines 125A, 125B and 126A, 126B, respectively. Each of optical sensors 120A, 120B has a detection field which is schematically illustrated by dashed lines and within which the position and alignment of viewing unit 200 can be detected.

Based on the information from the position detection unit 120, control unit 130 determines the contents of the field of view and transmits this content to viewing unit 200 via line 205. These contents of the field of view are also read in by test-conducting unit 140, i.e., via line 206. This is the actual field of view of viewing unit 200.

Test-conducting unit 140 determines a reference field of view independently thereof based on the information from the position detection unit 120 and calibrates this field of view with the actual field of view.

The test-conducting unit 140 is designed to position the holding device 110 by transmitting control information to the holding device 110 and to thus specify a reference position of the viewing unit 200. The reference position of the viewing unit 200 is subsequently transmitted to the control unit 130 of the visual system 101, and the field of view based on this reference position is determined by the control unit 130. This determined field of vision is the reference field of vision, based on the specified reference position of the holding device 110 and the viewing unit 200.

The position detection unit 120 determines the position and the alignment of the viewing unit 200 and transmits these to the control unit 130, so that the control unit 130 transmits field of view data to the viewing unit 200 based on the information from the position detection unit 120.

The test-conducting unit 140 is designed to read in the field of view data transmitted by the control unit 130 to the viewing unit 200. The field of view that is read in is the actual field of view.

Both the reference field of view and also the actual field of view can in particular be characterized in terms of the data or information that is to be displayed on the viewing unit 200, as well as its position on the viewing unit 200, so that a field-of-view calibration involves, e.g., a calibration of the data or information that is to be displayed, as well as its position.

By a calibration of the determined field of view with the field of view that is read in, the test-conducting unit 140 can determine whether the control unit 130 of the visual system 101 is transmitting the correct field of view, i.e., the field of view expected depending on the position and alignment of the viewing unit 200.

Before a test of this type is performed, position coordination of holding device 110 and the position coordinates determined by position detection unit 120 must be equalized. This can occur, e.g., in that viewing unit 200 is mechanically coupled to holding device 110, in particular, coupled to holding device 110 in a reversible and fixed manner. In the case of a viewing unit 200 in the form of a piece of headgear for a viewer, this coupling corresponds to the fitting of the headgear onto the head. The equalizing of the position of holding device 110 with the position of viewing unit 200 results in the reference field of view being equal to the actual field of view in this initial position.

The holding device 110 is moveable and is designed such that its position and alignment can be specified by the test-conducting unit 140. The holding device 119 can also be moved such that the movement has a rotational degree of freedom, i.e., that the holding device 110 can perform a rotational movement about a rotation axis 112, 113, 114.

Such a rotational movement of the holding device 110 corresponds to the change in the alignment of the viewing unit 200. In the context of use by a viewer, this is equivalent to the tilting or turning of the head, so that at least the viewing direction and the alignment of the viewing unit change.

The position detection unit 120 is designed to detect the position and the alignment of the viewing unit 200. The position detection unit 120 can comprise one or multiple sensors 120A, 120B. At least one sensor 120A, 120B can thereby be mechanically coupled to the viewing unit 200, i.e., designed such that it is integrated with the viewing unit 200, so that this at least one sensor 120A, 120B can detect a movement or positioning of the viewing unit 200. Furthermore, at least one sensor 120A, 120B can be arranged spatially separate (i.e., without a direct connection in the form of a mechanical coupling, via which a translational or rotational movement of the viewing unit 200 is directly transmitted to the sensor) from the viewing unit 200 and can, e.g., detect the position and the alignment of the viewing unit 200 via optical detectors 120A, 120B. In one embodiment, all sensors 120A, 120B of the position detection unit 120 can be mechanically coupled to the viewing unit 200. In another embodiment, all sensors 120A, 120B of the position detection unit 120 can be spatially separate from the viewing unit 200.

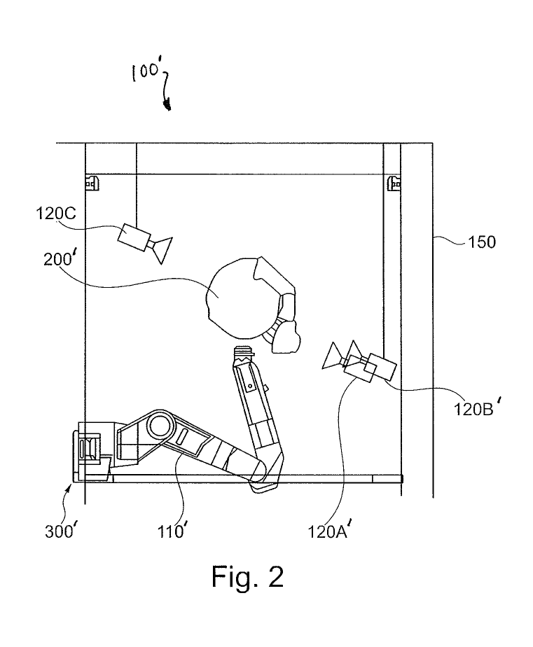

FIG. 2 shows a further embodiment of a testing apparatus 100′. As shown, holding device 110′, which can be embodied or formed as a six-segment robot atm, is attached to frame 150 at a position 300′. Viewing unit 200′, which can be, e.g., a helmet, is arranged at a free end of holding device 110′. This helmet can be moved to change its alignment in such a manner as is done by a pilot of an aircraft during flight, e.g., when the pilot turns his head to the left/right, when the pilot raises his head upwards or lowers it downwards, or when the pilot moves and/or holds his head in a tilted manner. These movements correspond to rotations of the helmet about each rotational axis.

The position and the alignment or the viewing direction of the helmet is detected by three optical sensors in the form of cameras 120A′, 120B′, 120C. The position signals of cameras 120A′, 120B′ and 120C are, as described in connection with the embodiment of FIG. 1, processed by test-conducting unit 140 and control unit 130.

The testing apparatus 100, 100′ carries out a procedure as follows: actuation of the holding device 110, 110′ by the test-conducting unit 140, so that the holding device 110, 110′ performs a movement which elicits a rotational movement on the viewing unit 200, 200′ about at least one rotation axis 112, 113, 114; detection of a position of the viewing unit 200, 200′ and detection of a spatial alignment of the viewing unit 200, 200′, each by the position detection unit 120; determination of a field of view based on the detected position and alignment; display of a field of view in the viewing unit 200, 200′ and reading in of the field of view displayed in the viewing unit 200, 200′; calibration of the field of view that is read in with the field of view determined by the test-conducting unit 140. Moreover, this procedure can be carried out cyclically and is particularly suitable for long-term tests of viewing units, in particular augmented viewing units.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A testing apparatus for testing visual systems having a viewing unit, comprising:
a moveable holding device, which is structured to hold the viewing unit and to move the viewing unit with a rotational degree of freedom;
a position detection unit structured to detect a position and an alignment of the viewing unit; and
a test-conducting unit coupled to receive a detected position and an alignment of the viewing unit from the position detection unit,
wherein the test-conducting unit is configured to determine a field of view as a function of the detected position and alignment of the viewing unit, to read-in an actual field of view displayed by the viewing unit and to compare the determined field of view with the read-in actual field of view.

2. The testing apparatus according to claim 1, wherein the visual systems further have a control unit, and the test-conducting unit is further configured to be coupleable to the control unit, and
wherein the control unit is configured to transmit a field of view to the viewing unit and the test-conducting unit, and the transmitted field of view is read-in by the test-conducting unit as the read-in actual field of view.

3. The testing apparatus according to claim 2, wherein the test-conducting unit is further configured to cyclically retrieve the detected position and alignment of the viewing unit from the position detection unit.

4. The testing apparatus according to claim 3, wherein the test-conducting unit is further configured to, after each retrieval of the detected position and alignment of the viewing unit, re-determine the field of view, read-in the field of view transmitted by the control unit and calibrate the re-determined field of view with the read-in field of view.

5. The testing apparatus according to claim 1, wherein the holding device is structured to move the viewing unit with three rotational degrees of freedom.

6. The testing apparatus according to claim 1, wherein the holding device is structured as a controllable robot arm.

7. The testing apparatus according to claim 6, wherein the robot arm comprises six segments that are separately controllable from one another to enable a positioning of the viewing unit along three translational and three rotational degrees of freedom.

8. The testing apparatus according to claim 1, wherein the position detection unit comprises at least one of an optical sensor, an accelerometer, a position sensor and an extensometers.

9. The testing apparatus according to claim 1, wherein the position detection unit comprises two optical sensors.

10. The testing apparatus according to claim 9, wherein each of the optical sensors form an image acquisition unit.

11. A method of testing, with the testing apparatus according to claim 1, an augmented visual system having a viewing unit, the method comprising:
moving the viewing unit with a rotational degree of freedom;
detecting the position and alignment of the viewing unit;
determining a field of view as a function of the detected position and alignment of the viewing unit; and
comparing the determined field of view with an actual field of view displayed by the viewing unit.

12. A method of testing an augmented visual system having a viewing unit, the method comprising:
moving the viewing unit with a rotational degree of freedom;
detecting the position and alignment of the viewing unit;
determining a field of view as a function of the detected position and alignment of the viewing unit; and
comparing the determined field of view with an actual field of view displayed by the viewing unit.

13. The method according to claim 12, wherein the augmented visual systems further have a control unit, and the method further comprises:
receiving, as the actual field of view displayed by the viewing unit, a field of view transmitted by the control unit to the viewing unit.

14. The method according to claim 13, further comprising cyclically retrieving the detected position and alignment of the viewing unit; and
after each retrieval of the cyclically retrieved detected position and alignment of the viewing unit:
re-determining the field of view;
reading-in the field of view transmitted by the control unit; and
calibrating the re-determined field of view with the read-in field of view.

15. The method according to claim 12, wherein the moving of the viewing unit with a rotational degree of freedom comprises moving the viewing unit with three rotational degrees of freedom.

16. The method apparatus according to claim 12, wherein the viewing unit is coupled to a controllable robot arm having six segments that are separately controllable from one another, and
wherein the moving of the viewing unit with a rotational degree of freedom comprises positioning the viewing unit along three translational and three rotational degrees of freedom.

17. The method according to claim 12, wherein the detecting of the position and alignment of the viewing unit comprises receiving signals from at least one of an optical sensor, an accelerometer, a position sensor and an extensometers.

18. The method according to claim 12, wherein the detecting of the position and alignment of the viewing unit comprises receiving signals from at least two optical sensors.

19. A testing apparatus for testing visual systems having a viewing unit and a control unit, comprising:
a holding device, which is structured to hold the viewing unit and to move the viewing unit along three rotational degree of freedom;
a position detection unit comprising at least two sensors structured and arranged to cyclically detect a position and the alignment of the viewing unit; and
a test-conducting unit coupled to receive the cyclically detected position and an alignment of the viewing unit from the position detection unit,
wherein, for each detected position and alignment of viewing unit, the test-conducting unit is configured to determine a field of view as a function of the detected position and alignment of the viewing unit, to read-in a field of view transmitted from the control unit to be displayed by the viewing unit and to compare the determined field of view with the read-in field of view.

20. The testing apparatus according to claim 19, wherein the test-conducting unit is further configured to calibrate the read-in field of view transmitted by the control unit based upon the comparison with the determined field of view.
